(19) United States
(12) Patent Application Publication
(10) Pub. No.: US 2026/0025065 A1
(43) Pub. Date: Jan. 22, 2026

(54) RESONANT POWER CONVERSION CIRCUIT AND CONTROL METHOD THEREOF FOR DISCHARGING RESONANT CAPACITOR DURING STARTUP

(71) Applicant: Richtek Technology Corporation, Zhubei City (TW)

(72) Inventors: Ta-Yung YANG, Taoyuan City (TW); Kuo-Chi LIU, Hsinchu City (TW); Hsin-Yi WU, Zhubei City (TW); Kun-Yu LIN, Zhubei City (TW)

(21) Appl. No.: 19/237,283

(22) Filed: Jun. 13, 2025

Related U.S. Application Data
(60) Provisional application No. 63/672,769, filed on Jul. 18, 2024.

(30) Foreign Application Priority Data
Feb. 10, 2025 (TW) 114104848

(51) Int. Cl. H02M 1/36; H02M 3/00; H02M 3/335

(52) U.S. Cl. CPC H02M 1/36; H02M 3/01; H02M 3/3353

(57) ABSTRACT

A power conversion circuit includes a transformer, a resonant capacitor, a high-side transistor, a low-side transistor, and a control circuit. The transformer includes a primary coil and a secondary coil, and the primary coil is coupled between a switch node and a resonant node. The resonant capacitor is coupled between the resonant node and a ground. The high-side transistor provides an input voltage to the switch node based on a high-side driving signal. The low-side transistor couples the switch node to the ground based on a low-side driving signal. The control circuit generates the high-side driving signal and the low-side driving signal. When the control circuit executes a startup process, the control circuit discharges the resonant capacitor.

### CROSS REFERENCE TO RELATED APPLICATIONS

This application claims the benefit of U.S. Provisional Application No. 63/672,769, filed on Jul. 18, 2024, the entirety of which is incorporated by reference herein.

This application claims priority of Taiwan Patent Application No. 114104848, filed on Feb. 10, 2025, the entirety of which is incorporated by reference herein.

### BACKGROUND OF THE INVENTION

### Field of the Invention

The disclosure is generally related to a power conversion circuit and a control method thereof, and more particularly it is related to a resonant power conversion circuit and a control method thereof for discharging a resonant capacitor during startup.

### Description of the Related Art

With the continuous advancements being made in portable electronic devices, the development of power conversion circuits, like most power products, is trending toward high efficiency, high power density, high reliability, and low cost. Since resonant power conversion circuits (which include LLC resonant power conversion circuits, flyback power conversion circuits, and others) are high-efficiency and high-power density power conversion circuits, the power conversion circuits used in portable electronic devices are gradually moving towards resonant power conversion circuits.

However, current resonant power conversion circuits still have many defects, so it is necessary to further optimize resonant power conversion circuits.

### BRIEF SUMMARY OF THE INVENTION

The present invention proposes a power conversion circuit and a control method thereof, which effectively maintains the ratio of the resonant voltage and the output voltage by discharging the resonant capacitor before driving the high-side transistor and the low-side transistor, thereby avoiding voltage spike on the secondary side and increasing the reliability of the circuit devices.

In an embodiment, a power conversion circuit is provided, which comprises a transformer, a resonant capacitor, a high-side transistor, a low-side transistor, and a control circuit. The transformer comprises a primary coil and a secondary coil, where the primary coil is coupled between a switch node and a resonant node. The resonant capacitor is coupled between the resonant node and a ground. The high-side transistor provides an input voltage to the switch node based on a high-side driving signal. The low-side transistor couples the switch node to the ground based on a low-side driving signal. The control circuit generates the high-side driving signal and the low-side driving signal. When the control circuit executes a startup process, the control circuit discharges the resonant capacitor.

According to an embodiment of the present invention, when the power conversion circuit receives the input voltage, the control circuit starts to execute the startup process. After the startup process, the power conversion circuit stably outputs an output voltage.

According to an embodiment of the present invention, when the power conversion circuit receives the input voltage, the control circuit starts to execute the startup process. When the startup process terminates, the control circuit starts generating the high-side driving signal and the low-side driving signal.

According to an embodiment of the present invention, the control circuit comprises a startup circuit. The startup circuit comprises a normally-on transistor, a startup transistor, a startup resistor, and a startup diode. The normally-on transistor is coupled to the input voltage. The startup transistor comprises a startup gate terminal, a startup drain terminal, and a startup source terminal, wherein the startup drain terminal is coupled to the normally-on transistor. The startup resistor is coupled between the startup gate terminal and the startup drain terminal. The startup diode comprises an anode and a cathode, wherein the anode is coupled to the startup source terminal, and the cathode generates a supply voltage. The control circuit is powered by the supply voltage during the startup process.

According to an embodiment of the present invention, the startup circuit further comprises a comparator. The comparator compares the supply voltage with a threshold voltage to generate a comparison result. The comparison result is provided to the startup gate terminal. When the supply voltage exceeds the threshold voltage, the comparator disables the comparison result to turn off the startup transistor. When the supply voltage does not exceed the threshold voltage, the input voltage enables the comparison result through the normally-on transistor and the startup resistor to turn on the startup transistor so that the startup transistor generates the supply voltage.

According to an embodiment of the present invention, the power conversion circuit further comprises a blocking transistor, a discharge resistor, and a discharge transistor. The discharge resistor is coupled between the blocking transistor and the resonant node. The discharge transistor comprises a discharge gate terminal, a discharge drain terminal, and a discharge source terminal. The discharge gate terminal receives the comparison result, the discharge drain terminal is coupled to the blocking transistor, and the discharge source terminal is coupled to the ground. The blocking transistor is normally on.

According to an embodiment of the present invention, when the control circuit executes the startup process, the input voltage turns on the discharge transistor through the normally-on transistor and the startup resistor so that the charge of the resonant capacitor is discharged to the ground through the discharge resistor, the blocking transistor, and the discharge transistor.

According to an embodiment of the present invention, when the supply voltage exceeds the threshold voltage, the comparator turns off the startup transistor to stop generating the supply voltage, and turns on the discharge transistor to stop discharging the resonant capacitor.

According to an embodiment of the present invention, when the supply voltage exceeds the threshold voltage, the control circuit terminates the startup process. When the startup circuit starts generating the supply voltage, the control circuit executes the startup process.

According to an embodiment of the present invention, the power conversion circuit further comprises a voltage generation circuit. The voltage generation circuit comprises a supply capacitor and a supply diode. The supply capacitor is configured to maintain the supply voltage. The supply diode is configured to unidirectionally charge the supply capacitor using an auxiliary coil voltage to generate the supply voltage, so as to prevent the supply voltage from affecting the operation of the transformer. The transformer further comprises an auxiliary coil. The auxiliary coil generates the auxiliary coil voltage. When the startup transistor turns off, the auxiliary coil generates the supply voltage to power the control circuit.

According to an embodiment of the present invention, when the auxiliary coil voltage generates the supply voltage, the startup diode is configured to isolate the supply voltage from the startup source terminal.

According to an embodiment of the present invention, the startup circuit further comprises a counter. The counter counts a counting time based on the comparison result being disabled. When the supply voltage exceeds the threshold voltage, the counter starts counting the counting time. When the counting time reaches a predetermined time, the control circuit starts generating the high-side driving signal and the low-side driving signal. The predetermined time is configured to determine the period for the control circuit to execute the startup process.

According to an embodiment of the present invention, the predetermined time exceeds 0.5 seconds.

According to an embodiment of the present invention, the power conversion circuit further comprises a discharge resistor. The discharge resistor is coupled to both terminals of the resonant capacitor. The resonant capacitor discharges through the discharge resistor during the startup process.

According to an embodiment of the present invention, the power conversion circuit is a resonant flyback power conversion circuit.

In another embodiment, a control method for controlling a power conversion circuit is provided. The power conversion circuit comprises a resonant capacitor coupled between a resonant node and a ground, a transformer comprising a primary coil and a secondary coil, a high-side transistor providing an input voltage to a switch node, and a low-side transistor coupling the switch node to the ground. The primary coil is coupled between the switch node and the resonant node. The control method comprises the following steps. The input voltage is received. After the step of receiving the input voltage, the resonant capacitor is discharged. After the step of discharging the resonant capacitor, the high-side transistor and the low-side transistor are driven.

According to an embodiment of the present invention, the power conversion circuit further comprises a startup circuit and a control circuit, and the transformer further comprises an auxiliary coil. The startup circuit generates a supply voltage using the input voltage. The control circuit is configured to perform the control method. When the supply voltage exceeds a threshold voltage, the auxiliary coil is configured to generate the supply voltage. The control circuit is powered by the supply voltage.

According to an embodiment of the present invention, the step of discharging the resonant capacitor further comprises the following steps. The supply voltage is generated by the startup circuit. When the supply voltage does not exceed the threshold, the resonant capacitor is discharged. When the supply voltage exceeds the threshold, the resonant capacitor is not discharged.

According to an embodiment of the present invention, the step of discharging the resonant capacitor further comprises the following steps. When the supply voltage exceeds the threshold, a counting time is counted. When the counting time reaches a predetermined time, the high-side transistor and the low-side transistor are driven.

According to an embodiment of the present invention, a discharge resistor is coupled to the resonant node, and the discharge resistor is configured to discharge the resonant capacitor.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a power conversion circuit in accordance with an embodiment of the present invention;

FIG. 2 is a waveform diagram of a power conversion circuit in accordance with an embodiment of the present invention;

FIG. 3 is a block diagram of a power conversion circuit according to another embodiment of the present invention;

FIG. 4 is a block diagram of a startup circuit in accordance with an e embodiment of the present invention;

FIG. 5 is a block diagram of a power conversion circuit in accordance with another embodiment of the present invention;

FIG. 6 is a block diagram of a startup circuit in accordance with another embodiment of the present invention; and

FIG. 7 is a flow chart of a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

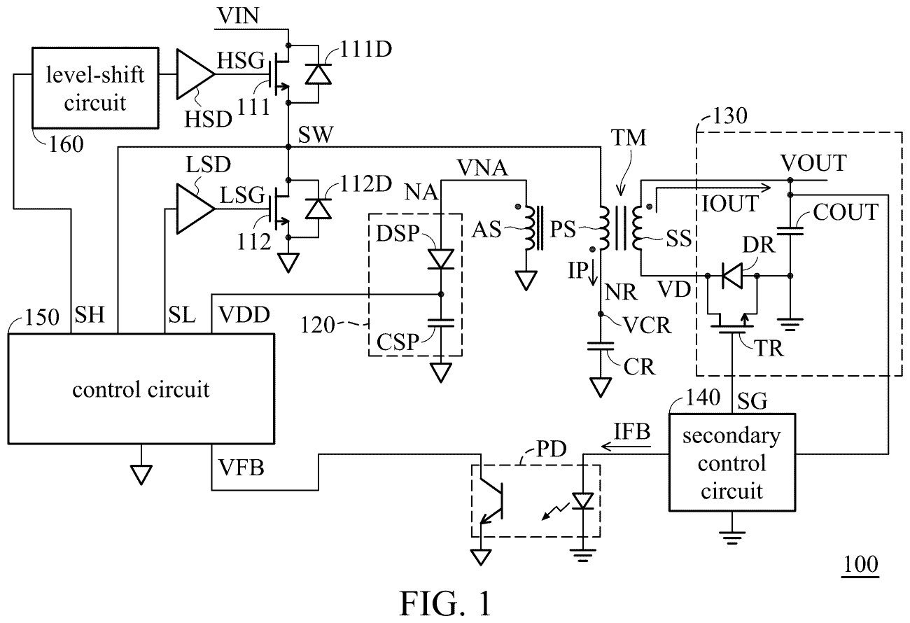

FIG. 1 is a block diagram of a power conversion circuit in accordance with an embodiment of the present invention. As shown in FIG. 1, the power conversion circuit 100 includes a high-side transistor 111, a low-side transistor 112, a resonant capacitor CR, a transformer TM, a voltage generation circuit 120, a rectification circuit 130, a secondary control circuit 140, an opto-coupler PD, a control circuit 150, a level-shift circuit 160, a high-side driving circuit HSD, and a low-side driving circuit LSD.

The high-side transistor 111 provides an input voltage VIN to a switch node SW based on a high-side gate driving signal HSG. According to an embodiment of the present invention, the high-side transistor 111 includes a high-side parasitic diode 111D, where the high-side parasitic diode 111D is coupled between the switch node SW and the input voltage VIN. The low-side transistor 112 couples the switch node SW to the ground based on the low-side gate driving signal LSG. According to an embodiment of the present invention, the low-side transistor 112 includes a low-side parasitic diode 112D, where the low-side parasitic diode 112D is coupled between the switch node SW and the ground.

The resonant capacitor CR is coupled between the resonant node NR and the ground, and a resonant voltage VCR is generated across the resonant capacitor CR. The transformer TM includes a primary coil PS, a secondary coil SS, and an auxiliary coil AS. The primary coil PS is coupled between the switch node SW and the resonant node NR. The auxiliary coil AS is coupled between the auxiliary node NA and the ground, and an auxiliary coil voltage VNA is generated at the auxiliary node NA. The output current IOUT generated by the secondary coil SS generates an output voltage VOUT through the rectification circuit 130.

According to some embodiments of the present invention, the primary coil PS and the resonant capacitor CR are connected in series between the switch node SW and the ground. In other words, the resonant capacitor CR may be coupled between the switch node SW and the resonant node NR, and the primary coil PS may be coupled between the resonant node NR and the ground.

The voltage generation circuit 120 is configured to generate a supply voltage VDD using the auxiliary coil voltage VNA, where the voltage generation circuit 120 includes a supply diode DSP and a supply capacitor CSP. The supply diode DSP is configured to charge the supply capacitor CSP unidirectionally using the auxiliary coil voltage VNA to generate the supply voltage VDD, so as to prevent the supply voltage VDD from affecting the operation of the transformer TM. According to an embodiment of the present invention, when the auxiliary coil voltage VNA generated by the auxiliary coil AS is less than the supply voltage VDD, the supply capacitor CSP is configured to maintain the supply voltage VDD.

The rectification circuit 130 is configured to convert the output current IOUT generated by the secondary coil SS into an output voltage VOUT, and includes a rectification transistor TR and an output capacitor COUT. According to some embodiments of the present invention, the rectification transistor TR further includes a rectification parasitic diode DR. The rectification transistor TR is turned on based on the gate signal SG, so that the output current IOUT output by the secondary coil SS charges the output capacitor COUT to generate the output voltage VOUT. When the rectification transistor TR is turned off, the voltage from the drain terminal to the source terminal of the rectification transistor TR is the drain voltage VD.

The secondary control circuit 140 generates a feedback current IFB based on the output voltage VOUT, where the feedback current IFB generates a feedback voltage VFB through the opto-coupler PD. The secondary control circuit 140 further generates the gate signal SG for converting the output current IOUT generated by the secondary coil SS into the output voltage VOUT.

The control circuit 150 is powered by the supply voltage VDD and generates a high-side driving signal SH and a low-side driving signal SL based on the feedback voltage VFB. The level-shift circuit 160 is configured to shift the voltage level of the high-side driving signal SH to the input voltage VIN, and the high-side drive circuit HSD generates the high-side gate driving signal HSG based on the shifted signal to drive the high-side transistor 111. The low-side driving circuit LSD generates a low-side gate driving signal LSG based on the low-side driving signal SL to drive the low-side transistor 112.

According to some embodiments of the present invention, the control circuit 150 further generates a high-side driving signal SH and a low-side driving signal SL according to the voltage of the switch node SW, so that both the high-side transistor 111 and the low-side transistor 112 achieve zero-voltage switching (ZVS) to improve the conversion efficiency of the power conversion circuit 100. According to some embodiments of the present invention, the power conversion circuit 100 may be a resonant power conversion circuit. According to some embodiments of the present invention, the power conversion circuit 100 may be a resonant flyback power conversion circuit. According to some embodiments of the present invention, the power conversion circuit 100 may be an asymmetrical half-bridge flyback power conversion circuit.

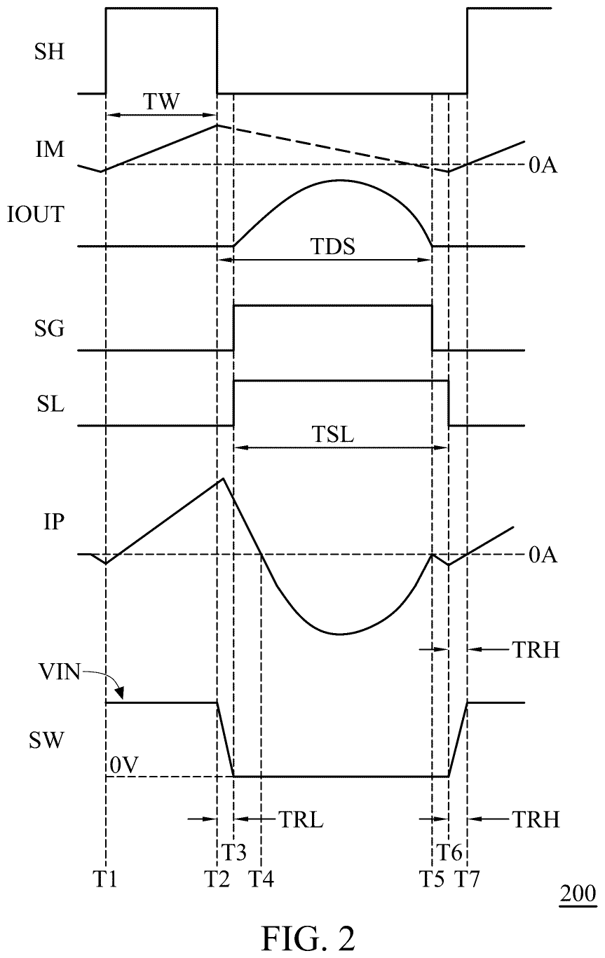

FIG. 2 is a waveform diagram of a power conversion circuit in accordance with an embodiment of the present invention. The following description of the waveform diagram 200 will be described in detail in conjunction with the power conversion circuit 100 of FIG. 1. From the first time point T1 to the second time point T2, the high-side transistor 111 is turned on based on the high-side driving signal SH (i.e., the high-side driving signal SH is at the high logic level). The high-side conduction time TW is the conduction time of the high-side transistor 111. During the high-side conduction time TW, the transformer TM is magnetized to generate a magnetizing current IM. As the conduction time TW increases, the magnetizing current IM of the transformer TM, the primary current IP flowing through the primary coil PS, and the resonant voltage VCR all increase accordingly. In other words, the high-side conduction time TW is the magnetizing time of the transformer TM.

When the high-side transistor 111 is turned off (i.e., the high-side driving signal SH is at the low logic level), the transformer 10 is demagnetizing. During the demagnetization period TDS, the transformer 10 generates an output current IOUT, and the conduction time of the low-side transistor 112 (i.e., the low-side driving signal SL is at the high logic level) corresponds to the demagnetization period TDS. According to some embodiments of the present invention, the low-side conduction time TSL of the low-side driving signal SL is equal to or greater than the demagnetization period TDS. During the demagnetization period TDS, the voltage across the primary coil PS is equal to the resonant voltage VCR, and the output voltage VOUT is as shown in Eq. 1.

$$VCR = n \times VOUT \\ n = \frac{NP}{NS} \qquad ( Eq . 1 )$$

NP is the number of turns of the primary coil PS, NS is the number of turns of the secondary coil SS, and the turn ratio n is the number of turns of the primary coil PS divided by the number of turns of the secondary coil SS.

The demagnetization period TDS is shown in Eq. 2.

$$TDS = \frac{( VIN - VCR ) \times TW}{n \times VOUT} \qquad ( Eq . 2 )$$

When the high-side transistor 111 is turned on, (VIN−VCR) is the voltage configured to magnetize the transformer TM.

At the second time point T2, the high-side driving signal SH is converted to the low logic level to turn off the high-side transistor 111. At the third time point T3, the low-side driving signal SL is converted to the high logic level to turn on the low-side transistor 112. According to some embodiments of the present invention, the first dead time TRL from the second time point T2 to the third time point T3 is the dead time from the high-side transistor 111 being turned off to the low-side transistor 112 being turned on.

According to some embodiments of the present invention, during the first dead time TRL, the circulating current generated by the primary coil PS turns on the low-side parasitic diode 112D, and pulls down the voltage of the switch node SW, so that the low-side transistor 112 reaches zero-voltage switching. At the third time point T3, the voltage across the primary coil PS is the resonant voltage VCR of the resonant capacitor CR.

From the third time point T3 to the fourth time point T4, the high-side transistor 111 is turned off, and the low-side transistor 112 is turned on under zero-voltage switching. The rectification transistor TR is turned on, so that the output current IOUT flows through the rectification transistor TR to generate an output voltage VOUT, where the output voltage VOUT is equal to the resonant voltage VCR divided by the turn ratio n, as shown in Eq. 1. In addition, the primary current IP is still positive and flows into the resonant capacitor CR.

According to some embodiments of the present invention, the leakage inductance of the primary coil PS and the resonant capacitor CR form a resonant tank. The output current IOUT is in the form of a sine wave, and the frequency is determined by the resonant frequency of the resonant circuit. The primary current IP is the reflection of the magnetizing current IM plus the output current IOUT.

From the fourth time point T4 to the fifth time point T5, the high-side transistor 111 is continuously turned off and the low-side transistor 112 is continuously turned on. The energy of the transformer TM is continuously transferred to the secondary winding SS, and the energy at this time is provided by the resonant capacitor CR. In addition, since the low-side transistor 112 is continuously turned on, the energy of the resonant capacitor CR is configured to bring the magnetizing current IM to a negative value.

At the fifth time point T5, the rectification transistor TR is not turned on based on the gate signal SG, thereby ending the demagnetization period TDS. From the fifth time point T5 to the sixth time point T6, the resonant capacitor CR continues to reversely magnetize the primary winding PS, so that the primary current IP remains negative until the low-side transistor 112 is turned off.

From the sixth time point T6 to the seventh time point T7, the high-side transistor 111 and the low-side transistor 112 are both turned off, and the primary current IP induced as a negative current from the fifth time point T5 to the sixth time point T6 turns on the high-side parasitic diode 111D, so that the voltage of the switch node SW rises to the input voltage VIN. According to some embodiments of the present invention, the second dead time TRH from the sixth time point T6 to the seventh time point T7 is the dead time from the low-side transistor 112 being turned off to the high-side transistor 111 being turned on.

At the seventh time point T7, the high-side driving signal SH is at the high logic level. Since the voltage of the switch node SW rises to the input voltage VIN, the high-side transistor 111 is able to be turned under zero-voltage switching.

Since the resonant capacitor CR is connected in parallel with the primary coil PS when the transformer TM is demagnetized, the resonant voltage VCR is the output voltage VOUT multiplied by the turn ratio of the transformer TM. When the voltage difference between the resonant voltage VCR and the output voltage VOUT multiplied by the turn ratio is too large, the drain voltage VD would generate a very high voltage spike, reducing the reliability of the rectification transistor TR and even damaging the rectification transistor TR.

Under normal operation, the resonant voltage VCR would be very close to the voltage value of the output voltage VOUT multiplied by the turn ratio of the transformer TM, thereby avoiding the generation of voltage spike at the drain voltage VD. However, when the power conversion circuit 100 is turned on and off quickly and frequently, the output voltage VOUT would be discharged through the load, making the difference between the resonant voltage VCR and the output voltage VOUT multiplied by the turn ratio of the transformer TM significant, thereby causing a voltage spike at the drain voltage VD. In order to protect the rectification transistor TR from being damaged by voltage spike, it is necessary to optimize the power conversion circuit 100.

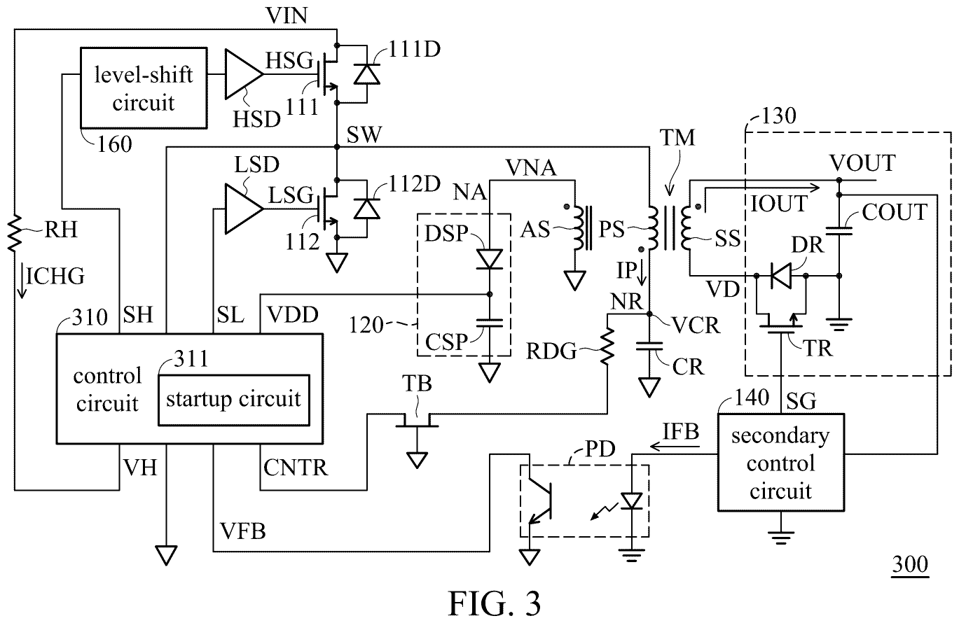

FIG. 3 is a block diagram of a power conversion circuit according to another embodiment of the present invention. Comparing the power conversion circuit 300 of FIG. 3 with the power conversion circuit 100 of FIG. 1, the power conversion circuit 300 further includes a charging resistor RH, a discharge resistor RDG, and a blocking transistor TB, and the control circuit 310 of the power conversion circuit 300 further includes a startup circuit 311.

The input voltage VIN is down-converted through the charging resistor RH to generate a high voltage VH. According to some embodiments of the present invention, the input voltage VIN generates a charging current ICHG through the charging resistor RH, thereby generating a down-converted high voltage VH. When the power conversion circuit 300 executes a startup process, the startup circuit 311 discharges the resonant capacitor CR through the discharge resistor RDG and the blocking transistor TB by the control signal CNTR. In addition, the startup circuit 311 generates a supply voltage VDD during the startup process, and uses the supply voltage VDD to power the control circuit 310.

The gate terminal of the blocking transistor TB is coupled to the ground to withstand the high voltage. The discharge resistor RDG is configured to limit the discharge current of the resonant capacitor CR. According to some embodiments of the present invention, the discharge resistor RDG and the blocking transistor TB are configured to discharge the resonant voltage VCR to a level close to the ground level when the high-side transistor 111 and the low-side transistor 112 are not driven.

According to some embodiments of the present invention, the blocking transistor TB may be a normally-on transistor. According to some embodiments of the present invention, the blocking transistor TB may be a normally-on junction field effect transistor. According to other embodiments of the present invention, when the element in the startup circuit 311 configured to generate the control signal CNTR may withstand the high voltage of the resonant voltage VCR, the blocking transistor TB may be omitted as well. According to some embodiments of the present invention, since the control circuit 310 discharges the resonant capacitor CR during the startup process, it may effectively avoid the voltage spike at the drain voltage VD, thereby protecting the rectification transistor TR.

According to some embodiments of the present invention, when the power conversion circuit 100 receives the input voltage VIN, the control circuit 310 starts executing the startup process, and after the startup process, the power conversion circuit 100 stably outputs the output voltage VOUT. In other words, the startup process can be defined as from the power conversion circuit 100 receiving the input voltage VIN to the power conversion circuit 100 stably outputting the output voltage VOUT.

According to other embodiments of the present invention, when the power conversion circuit 100 receives the input voltage VIN, the power conversion circuit 100 executes the startup process, and when the startup process terminates, the control circuit 310 starts generating the high-side drive signal SH and the low-side drive signal SL. In other words, the startup process can also be defined as from the power conversion circuit 100 receiving the input voltage VIN to the control circuit 310 starting to drive the high-side transistor 111 and the low-side transistor 112.

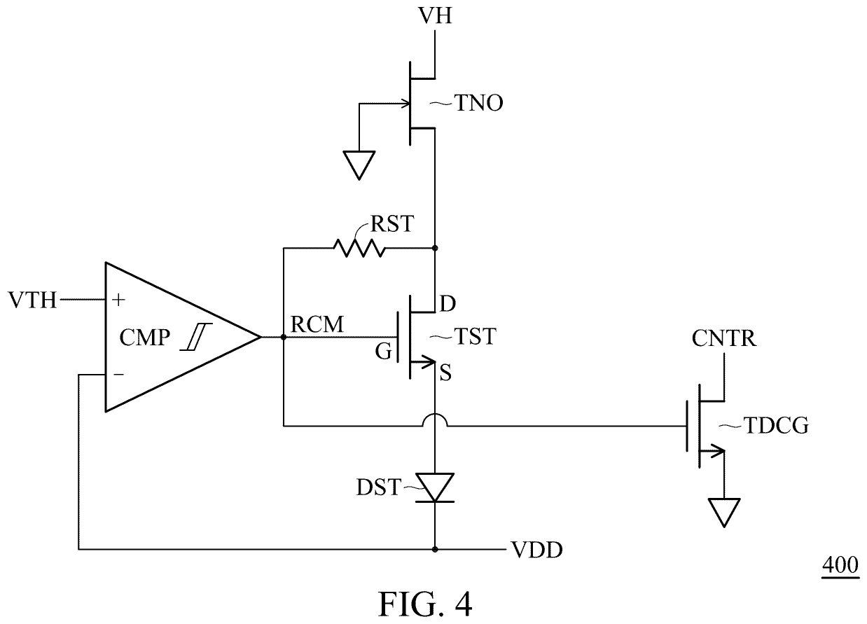

FIG. 4 is a block diagram of a startup circuit in accordance with an e embodiment of the present invention. As shown in FIG. 4, the startup circuit 400 includes a normally-on transistor TNO, a startup transistor TST, a startup resistor RST, a startup diode DST, a comparator CMP, and a discharge transistor TDCG. According to some embodiments of the present invention, the startup circuit 400 corresponds to the startup circuit 311.

The gate terminal of the normally-on transistor TNO is coupled to the ground and receives the high voltage VH generated by the charging resistor RH in FIG. 3. According to some embodiments of the present invention, the charging resistor RH may be omitted, and the input voltage VIN is directly provided to the normally-on transistor TNO. The startup transistor TST includes a gate terminal G, a drain terminal D, and a source terminal S, where the startup resistor RST is coupled to the gate terminal G and the drain terminal D. The startup diode DST is coupled between the source terminal S and the supply voltage VDD in FIG. 3.

According to some embodiments of the present invention, the startup diode DST is configured to unidirectionally charge the supply voltage VDD. According to some embodiments of the present invention, when the startup transistor TST is turned off, the startup diode DST is configured to isolate the supply voltage VDD from the source terminal S. The comparator CMP is configured to compare the supply voltage VDD and the threshold voltage VTH to provide a comparison result RCM to the gate terminal G. According to some embodiments of the present invention, when the supply voltage VDD exceeds the threshold voltage VTH, the comparator CMP disables the comparison result RCM and turns off the startup transistor TST and the discharge transistor TDCG. According to some embodiments of the present invention, the comparator CMP has hysteresis.

According to some embodiments of the present invention, when the comparator CMP turns off the startup transistor TST, the output terminal of the comparator CMP couples the gate terminal G of the startup transistor TST and the gate terminal of the discharge transistor TDCG to the ground, where the resistance values of the charging resistor RH and the startup resistor RST are configured to determine the current flowing through the normally-on transistor TNO. According to some embodiments of the present invention, the current flowing through the charging resistor RH, the normally-on transistor TNO, and the startup resistor RST is the charging current ICHG of FIG. 3.

According to some embodiments of the present invention, when the input voltage VIN is provided to the power conversion circuit 300, the output terminal of the comparator CMP is floated to the gate terminal G of the startup transistor TST, and the input voltage VIN enables the comparison result RCM through the charging resistor RH, the normally-on transistor TNO, and the startup resistor RST, thereby turning on the startup transistor TST and the discharge transistor TDCG. In other words, when the supply voltage VDD does not exceed the threshold voltage VTH, the output terminal of the comparator CMP is electrically isolated from the startup transistor TST, and the startup transistor TST is turned on by the input voltage VIN through the charging resistor RH, the normally-on transistor TNO and the startup resistor RST.

When the startup transistor TST is turned on, the input voltage VIN charges the supply capacitor CSP via the normally-on transistor TNO, the startup transistor TST, and the startup diode DST to generate the supply voltage VDD, where the supply voltage VDD is configured to power the control circuit 310. In other words, once the input voltage VIN is provided to the power conversion circuit 300, the startup circuit 400 immediately generates the supply voltage VDD to power the control circuit 310. According to some embodiments of the present invention, the supply voltage VDD may power the comparator CMP.

According to other embodiments of the present invention, when the high voltage VH continues to charge the supply capacitor CSP through the normally-on transistor TNO, the startup transistor TST, and the startup diode DST and causes the supply voltage VDD to exceed the threshold voltage VTH, the comparator CMP disables the comparison result RCM to turn off the startup transistor TST and the discharge transistor TDCG, which means that the power conversion circuit 300 has completed the startup process. The control circuit 310 then drives the high-side transistor 111 and the low-side transistor 112 based on the disabled comparison result RCM. When the startup transistor TST is not turned on, the startup circuit 400 stops generating the supply voltage VDD.

According to some embodiments of the present invention, since the startup circuit 400 generates the supply voltage VDD once the input voltage VIN is provided to the power conversion circuit 300, and the control circuit 310 starts driving the high-side transistor 111 and the low-side transistor 112 after the startup circuit 400 stops generating the supply voltage VDD, the period during which the supply voltage VDD is generated by the startup circuit 400 may be regarded as a startup process.

In other words, the startup process may be defined as the period from when the startup circuit 400 starts generating the supply voltage VDD to when the startup circuit 400 stops generating the supply voltage VDD, and the control circuit 310 starts driving the high-side transistor 111 and the low-side transistor 112 based on the disabled comparison result RCM.

According to some embodiments of the present invention, when the startup circuit 400 stops generating the supply voltage VDD, since the control circuit 310 starts driving the high-side transistor 111 and the low-side transistor 112, the auxiliary coil AS then generates the supply voltage VDD to power the control circuit 311. In other words, when the comparison result RCM is disabled, the startup circuit 400 stops generating the supply voltage VDD, and the auxiliary coil AS starts generating the supply voltage VDD.

When the input voltage VIN turns on the startup transistor TST through the charging resistor RH, the normally-on transistor TNO, and the startup resistor RST in FIG. 3, the discharge transistor TDCG is turned on at the same time and couples the control signal CNTR to the ground, so that the resonant capacitor CR is discharged through the discharge resistor RDG, the blocking transistor TB, and the discharge transistor TDCG.

When the resonant capacitor CR is discharged until the supply voltage VDD exceeds the threshold voltage VTH, the resonant voltage VCR is very close to the ground level. At this time, the control circuit 310 may drive the high-side transistor 111 and the low-side transistor 112 based on the disabled comparison result RCM. In addition, the startup process terminates once the control circuit 310 starts driving the high-side transistor 111 and the low-side transistor 112.

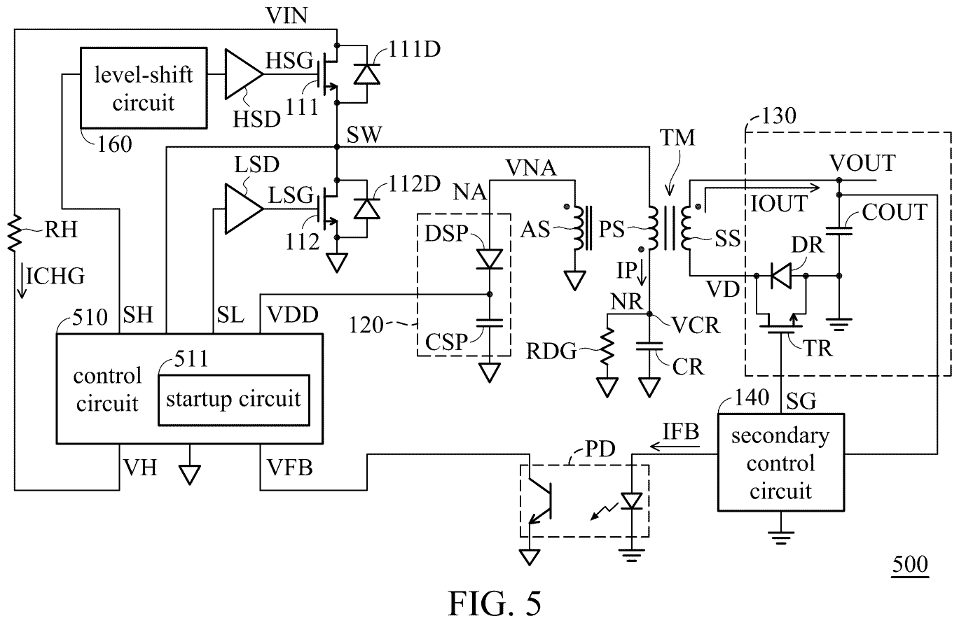

FIG. 5 is a block diagram of a power conversion circuit in accordance with another embodiment of the present invention. Compared to the power conversion circuit 100 of FIG. 1, the power conversion circuit 500 of FIG. 5 further includes a discharge resistor RDG, and the control circuit 510 of the power conversion circuit 500 further includes a startup circuit 511.

As shown in FIG. 5, the discharge resistor RDG is coupled to both terminals of the resonant capacitor CR to continuously discharge the resonant voltage VCR. According to some embodiments of the present invention, the discharge resistor RDG of FIG. 5 must be large enough to avoid excessive power loss. When the power conversion circuit 500 receives the input voltage VIN, the startup circuit 511 is configured to delay the control circuit 510 from driving the high-side transistor 111 and the low-side transistor 112 so that the discharge resistor RDG has enough time to discharge the resonant voltage VCR to a level close to the ground level.

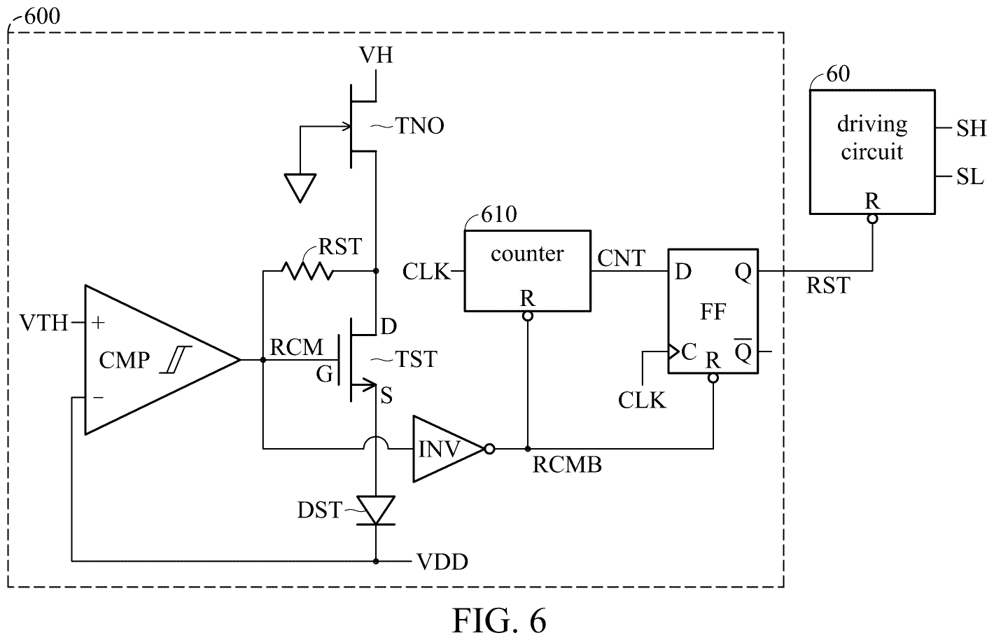

FIG. 6 is a block diagram of a startup circuit in accordance with another embodiment of the present invention. According to some embodiments of the present invention, the startup circuit 600 corresponds to the startup circuit 511 of FIG. 5. Compared to the startup circuit 400 of FIG. 4, the startup circuit 600 omits the discharge transistor TDCG of the startup circuit 400, and further includes an inverter INV, a counter 610, and a flip-flop FF.

As shown in FIG. 6, when the supply voltage VDD does not exceed the threshold voltage VTH, the comparator CMP does not have any effect on the gate terminal G of the startup transistor TST, and the high voltage VH enables the comparison result RCM through the normally-on transistor TNO and the startup resistor RST to turn on the startup transistor TST, indicating that the comparison result RCM is at a high voltage level. The inverter INV inverts the comparison result RCM to generate an inverted comparison result RCMB. The inverted comparison result RCMB resets the counter 610 and the flip-flop FF, and disables the counting signal CNT and the reset signal RST.

The driving circuit 60 stops generating the high-side driving signal SH and the low-side driving signal SL based on the disabled reset signal RST. According to some embodiments of the present invention, the control circuit 510 further includes a driving circuit 60, where the driving circuit 60 is configured to generate the high-side driving signal SH and the low-side driving signal SL to drive the high-side transistor 111 and the low-side transistor 112 respectively.

When the supply voltage VDD exceeds the threshold voltage VTH, the comparator CMP disables the comparison result RCM, so that the counter 610 starts counting a counting time based on the clock signal CLK. When the counting time reaches a predetermined time, the counter 610 enables the counting signal CNT. The flip-flop FF enables the reset signal RST based on the clock signal CLK and the enabled counting signal CNT, thereby enabling the driving circuit 60 to start generating the high-side driving signal SH and the low-side driving signal SL to drive the high-side transistor 111 and the low-side transistor 112 respectively.

According to some embodiments of the present invention, when the counter 610 counts, the control circuit 510 performs a startup process. In other words, the startup process can be defined as the time from when the startup circuit 600 stops generating the supply voltage VDD to when the driving circuit 60 starts driving the high-side transistor 111 and the low-side transistor 112. According to some embodiments of the present invention, the predetermined time exceeds 0.5 seconds. In other words, the duration of the startup process exceeds 0.5 seconds. That is, before driving the high-side transistor 111 and the low-side transistor 112, the resonant capacitor CR is discharged for at least 0.5 seconds.

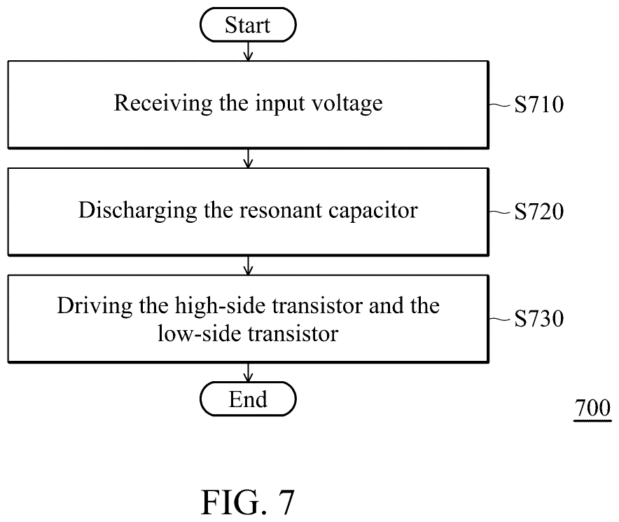

FIG. 7 is a flow chart of a control method in accordance with an embodiment of the present invention. As shown in the control method 700 of FIG. 7, first, the input voltage VIN is received (Step S710). After receiving the input voltage VIN, the startup process is executed to discharge the resonant capacitor CR (Step S720). After discharging the resonant capacitor, the high-side transistor 111 and the low-side transistor 112 are driven (Step S730).

In the embodiments of FIGS. 3 and 4, when the power conversion circuit 300 receives the input voltage VIN (Step S710), the startup transistor TST and the discharge transistor TDCG of FIG. 4 are turned on, and the resonant capacitor CR is discharged through the discharge resistor RDG and the blocking transistor TB of FIG. 3 and the discharge transistor TDCG of FIG. 4 (Step S720). When the comparison result RCM is disabled, the startup transistor TST and the discharge transistor TDCG are both turned off, and the control circuit 310 starts driving the high-side transistor 111 and the low-side transistor 112 based on the disabled comparison result RCM (Step S730).

In the embodiments of FIGS. 5 and 6, when the power conversion circuit 500 receives the input voltage VIN (Step S710), the startup circuit 600 generates the supply voltage VDD. When the supply voltage VDD exceeds the threshold voltage VTH, the startup circuit 600 stops generating the supply voltage VDD and the counter 610 starts counting a counting time. When the counting time is less than the predetermined time, the discharge resistor RDG continues to discharge the resonant capacitor CR (Step S720) and the driving circuit 60 stops generating the high-side driving signal SH and the low-side driving signal SL. When the counting time counted by the counter 610 reaches the predetermined time, the driving circuit 60 starts generating the high-side driving signal SH and the low-side driving signal SL to drive the high-side transistor 111 and the low-side transistor 112 respectively.

The present invention proposes a power conversion circuit and a control method thereof, which effectively maintains the ratio of the resonant voltage and the output voltage by discharging the resonant capacitor before driving the high-side transistor and the low-side transistor, thereby avoiding voltage spike on the secondary side and increasing the reliability of the circuit devices.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil and a secondary coil, wherein the primary coil is coupled between a switch node and a resonant node;
a resonant capacitor, coupled between the resonant node and a ground;
a high-side transistor, providing an input voltage to the switch node based on a high-side driving signal;
a low-side transistor, coupling the switch node to the ground based on a low-side driving signal; and
a control circuit, generating the high-side driving signal and the low-side driving signal;
wherein when the control circuit executes a startup process, the control circuit discharges the resonant capacitor.

2. The power conversion circuit as claimed in claim 1, wherein when the power conversion circuit receives the input voltage, the control circuit starts to execute the startup process;
wherein after the startup process, the power conversion circuit stably outputs an output voltage.

3. The power conversion circuit as claimed in claim 1, wherein when the power conversion circuit receives the input voltage, the control circuit starts to execute the startup process;
wherein when the startup process terminates, the control circuit starts generating the high-side driving signal and the low-side driving signal.

4. The power conversion circuit as claimed in claim 1, wherein the control circuit comprises:
a startup circuit, comprising:
a normally-on transistor, coupled to the input voltage;
a startup transistor, comprising a startup gate terminal, a startup drain terminal, and a startup source terminal, wherein the startup drain terminal is coupled to the normally-on transistor;
a startup resistor, coupled between the startup gate terminal and the startup drain terminal; and
a startup diode, comprising an anode and a cathode, wherein the anode is coupled to the startup source terminal, and the cathode generates a supply voltage;
wherein the control circuit is powered by the supply voltage during the startup process.

5. The power conversion circuit as claimed in claim 4, wherein the startup circuit further comprises:
a comparator, comparing the supply voltage with a threshold voltage to generate a comparison result;
wherein the comparison result is provided to the startup gate terminal;
wherein when the supply voltage exceeds the threshold voltage, the comparator disables the comparison result to turn off the startup transistor;
wherein when the supply voltage does not exceed the threshold voltage, the input voltage enables the comparison result through the normally-on transistor and the startup resistor to turn on the startup transistor so that the startup transistor generates the supply voltage.

6. The power conversion circuit as claimed in claim 5, further comprising:
a blocking transistor;
a discharge resistor, coupled between the blocking transistor and the resonant node; and
a discharge transistor, comprising a discharge gate terminal, a discharge drain terminal, and a discharge source terminal;
wherein the discharge gate terminal receives the comparison result, the discharge drain terminal is coupled to the blocking transistor, and the discharge source terminal is coupled to the ground;
wherein the blocking transistor is normally on.

7. The power conversion circuit as claimed in claim 6, wherein when the control circuit executes the startup process, the input voltage turns on the discharge transistor through the normally-on transistor and the startup resistor so that a charge of the resonant capacitor is discharged to the ground through the discharge resistor, the blocking transistor, and the discharge transistor.

8. The power conversion circuit as claimed in claim 7, wherein when the supply voltage exceeds the threshold voltage, the comparator turns off the startup transistor to stop generating the supply voltage, and turns on the discharge transistor to stop discharging the resonant capacitor.

9. The power conversion circuit as claimed in claim 8, wherein when the supply voltage exceeds the threshold voltage, the control circuit terminates the startup process;
wherein when the startup circuit starts generating the supply voltage, the control circuit executes the startup process.

10. The power conversion circuit as claimed in claim 7, further comprising:
a voltage generation circuit, comprising:
a supply capacitor, configured to maintain the supply voltage; and
a supply diode, configured to unidirectionally charge the supply capacitor using an auxiliary coil voltage to generate the supply voltage, so as to prevent the supply voltage from affecting operation of the transformer;
wherein the transformer further comprises:
an auxiliary coil, generating the auxiliary coil voltage;
wherein when the startup transistor turns off, the auxiliary coil generates the supply voltage to power the control circuit.

11. The power conversion circuit as claimed in claim 10, wherein when the auxiliary coil voltage generates the supply voltage, the startup diode is configured to isolate the supply voltage from the startup source terminal.

12. The power conversion circuit as claimed in claim 5, wherein the startup circuit further comprises:
a counter, counting a counting time based on the comparison result being disabled;
wherein when the supply voltage exceeds the threshold voltage, the counter starts counting the counting time;
wherein when the counting time reaches a predetermined time, the control circuit starts generating the high-side driving signal and the low-side driving signal;
wherein the predetermined time is configured to determine the period for the control circuit to execute the startup process.

13. The power conversion circuit as claimed in claimed 12, wherein the predetermined time exceeds 0.5 seconds.

14. The power conversion circuit as claimed in claimed 12, further comprising:
a discharge resistor, coupled to both terminals of the resonant capacitor;
wherein the resonant capacitor discharges through the discharge resistor during the startup process.

15. The power conversion circuit as claimed in claimed 1, wherein the power conversion circuit is a resonant flyback power conversion circuit.

16. A control method for controlling a power conversion circuit, wherein the power conversion circuit comprises a resonant capacitor coupled between a resonant node and a ground, a transformer comprising a primary coil and a secondary coil, a high-side transistor providing an input voltage to a switch node, and a low-side transistor coupling the switch node to the ground, wherein the primary coil is coupled between the switch node and the resonant node, wherein the control method comprises:
receiving the input voltage;
after the step of receiving the input voltage, discharging the resonant capacitor; and
after the step of discharging the resonant capacitor, driving the high-side transistor and the low-side transistor.

17. The control method as claimed in claim 16, wherein the power conversion circuit further comprises a startup circuit and a control circuit, wherein the transformer further comprises an auxiliary coil;
wherein the startup circuit generates a supply voltage using the input voltage;
wherein the control circuit is configured to perform the control method;
wherein when the supply voltage exceeds a threshold voltage, the auxiliary coil is configured to generate the supply voltage;
wherein the control circuit is powered by the supply voltage.

18. The control method as claimed in claim 17, wherein the step of discharging the resonant capacitor further comprises:
using the startup circuit to generate the supply voltage;
when the supply voltage does not exceed the threshold, discharging the resonant capacitor; and
when the supply voltage exceeds the threshold, stopping the resonant capacitor from discharging.

19. The control method as claimed in claim 17, wherein the step of discharging the resonant capacitor further comprises:
when the supply voltage exceeds the threshold, counting a counting time; and
when the counting time reaches a predetermined time, driving the high-side transistor and the low-side transistor.

20. The control method as claimed in claim 16, wherein a discharge resistor is coupled to the resonant node, and the discharge resistor is configured to discharge the resonant capacitor.
